(19) United States
(12) Patent Application Publication
(10) Pub. No.: US 2004/0041430 A1
(43) Pub. Date: Mar. 4, 2004

(54) Convertible jump seat for a pickup truck

(76) Inventor: Cleveland Lee Harvey, Neptune, NJ (US)

Correspondence Address: Wheeler Law Offices, P.C., P.O. Box 22035, Pittsburgh, PA, 15222, US

(21) Appl. No.: 10/234,225

(22) Filed: Sep. 4, 2002

(51) Int. Cl. B60N 2/005

(52) U.S. Cl. 296/64

(57) ABSTRACT

The present invention discloses a convertible jump seat for a pickup truck. It is an add-on seat for the rear cargo area, or bed, of a pickup truck. The convertible jump seat for a pickup truck an be easily removed to increase the truck's cargo carrying capacity, in the preferred embodiment, the backs of the seats also fold down to provide additional room in the bed of the pickup truck when no additional seating is needed, without removing the entire unit. In addition, a cargo/storage area is provided in front of the seats. The convertible jump seat for a pickup truck can be used in an open bed or with trucks that have bed caps.

### FIELD OF THE INVENTION

The present invention relates generally to vehicle seating. More specifically, the present invention relates to a removable seat for the bed of a pickup truck.

### BACKGROUND OF THE INVENTION

The pickup truck has become one of the most popular vehicles on the road today. No longer used primarily as a company or work vehicle, the pickup truck is now being purchased as a family vehicle, due to its convenience and the availability of options that make the ride as comfortable as many cars. The use of pickup trucks comes with some drawbacks, however. On average, a non-extended cab pickup truck has the capacity to carry a maximum of only three individuals, whereas an extended cab pickup truck can carry more passengers, but often has a smaller bed and less cargo capacity. Accordingly, the need exists for a means by which the passenger carrying capacity of a pickup truck can be easily temporarily increased without permanently affecting its ability to carry cargo. The present invention fulfills this need.

Previous patents have issued regarding removable pickup truck bed seating. U.S. Pat. No. 5,501,501 issued in the name of White et al., U.S. Pat. No. 5,029,928 issued in the name of Huber, U.S. Pat. No. 3,840,263 issued in the name of Bowden and U.S. Pat. No. 4,750,778 issued in the name of Hoban all disclose a single seat assembly without a frame structure that is mounted facing rearward onto the bed of a pickup truck.

U.S. Pat. No. 5,516,179, issued in the name of Tidwell, discloses a truck bed seat wherein the back of the seat is fastened to the frame such that it cannot be easily folded down for storage within the truck bed and the frame disclosed therein does not have rollers for easy installation and removal.

The present invention approves upon the foregoing issued patents.

### SUMMARY OF THE INVENTION

The present invention, the convertible jump seat for a pickup truck, is an add-on seat for the rear cargo area, or bed, of a pickup truck. The preferred embodiment of the present invention provides seating space for three additional passengers. The seats are mounted onto a common frame. The frame has casters on the bottom that allow the seats to be rolled up to and in and out of the truck bed, easing installation and removal. Once in the bed, the convertible jump seat for a pickup truck is bolted into place for safety. Eventhough the seats can be easily removed to increase the truck's cargo carrying capacity, in the preferred embodiment, the backs of the seats also fold down to provide additional room in the bed of the pickup truck when no additional seating is needed, without removing the entire unit. In addition, a cargo/storage area is provided in front of the seats. The convertible jump seat for a pickup truck can be used in an open bed or with trucks that have bed caps. The use of the convertible jump seat for a pickup truck provides additional, comfortable seating in a pickup truck without permanently affecting the cargo carrying capacity of the pickup truck and without increasing the overall size of the pickup truck.

It is an object of the present invention to provide removable seating for the bed of a pickup truck.

It is another object of the present invention to increase the seating capacity of a standard pickup truck.

It is yet another object of the present invention to provide additional seating capacity for a pickup truck without increasing the overall size of said pickup truck and without permanently reducing the cargo carrying capacity of a standard pickup truck.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is perspective view of the preferred embodiment of the convertible jump seat for a pickup truck.

FIG. 2 is perspective view of the convertible jump seat for a pickup truck installed on the tailgate of a pickup truck with a bed cover.

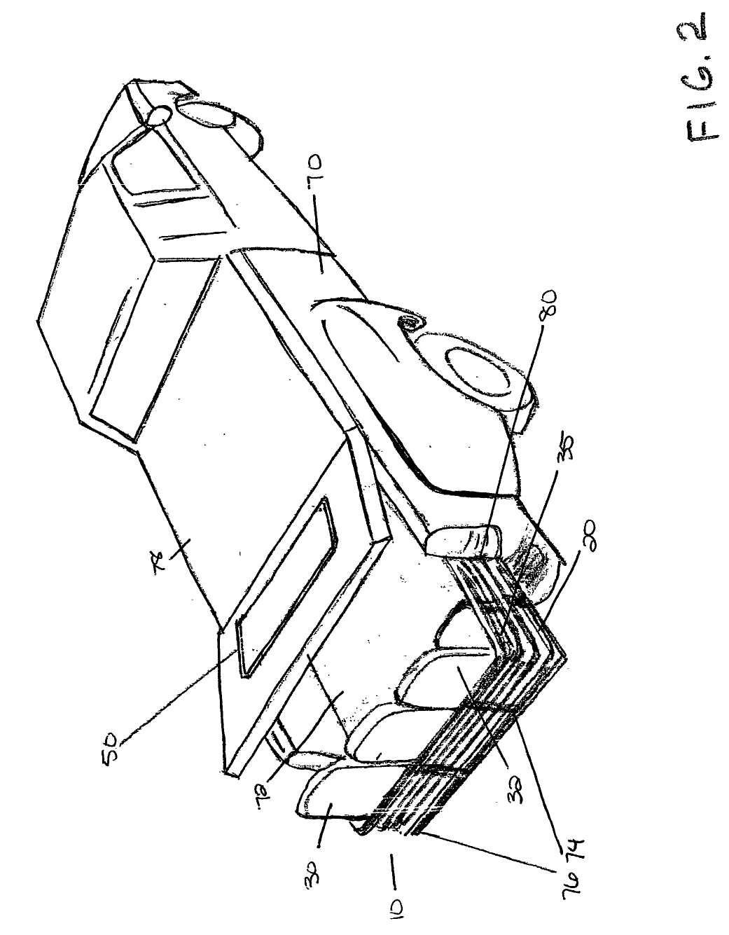

FIG. 3 is perspective view of the convertible jump seat for a pickup truck installed within the bed of the pickup truck.

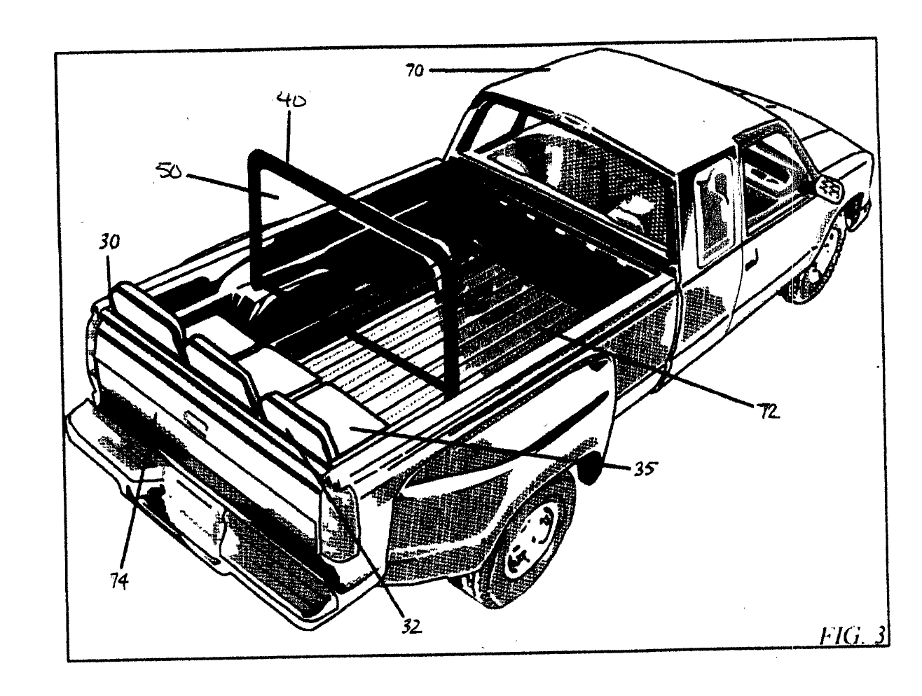

### DETAILED DESCRIPTION OF THE INVENTION

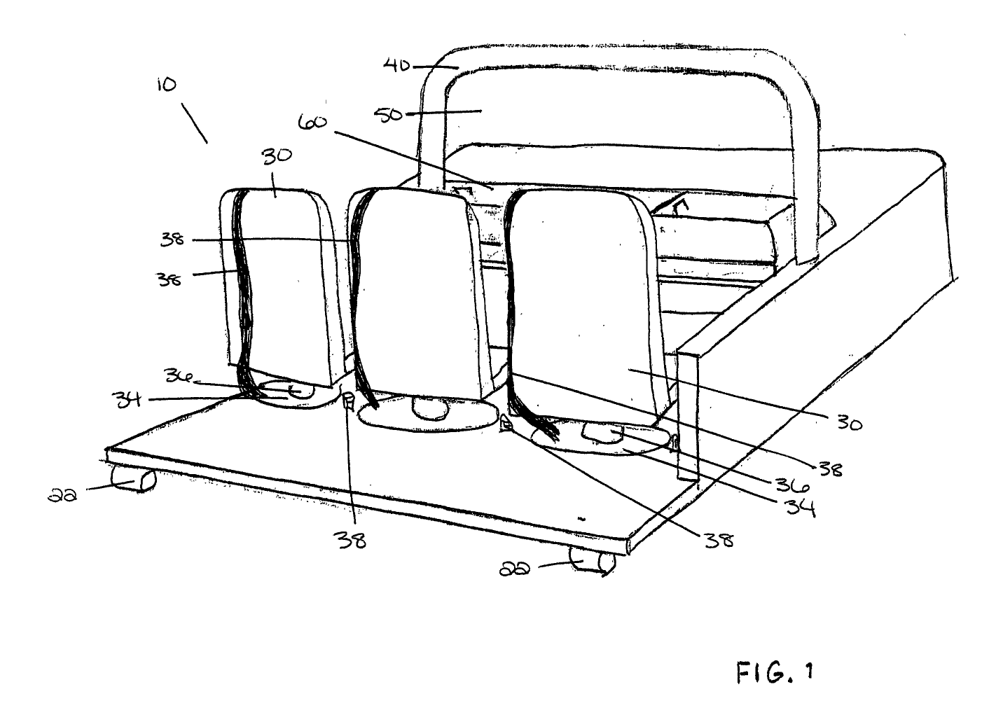

The preferred embodiment of the convertible jump seat for a pickup truck 10 is shown in FIG. 1. The preferred embodiment of the convertible jump seat for a pickup truck 10 has a unit base/frame 20, seats 30, a roll bar 40, a windshield 50 and a storage cabinet 60. It is preferred that the unit base/frame 20 is molded out of fiberglass. One of ordinary skill in the art would readily recognize, however, that the unit base/frame 20 can be made separately out of a number of different materials, including, but not limited to, wood. In the preferred embodiment, the underside of the unit base 20 has casters 22 securely fastened thereto for easy maneuvering thereof.

In the preferred embodiment, the convertible jump seat for a pickup truck 10 has three seats 30. The seats 30 preferably have high backs 32 such that the average passenger's head does not rise above the seat back 32 when seated. One of ordinary skill in the art would readily recognize, however, that a number of different seat designs can be substituted for that described herein, including, but not limited to, low backed seats. The seats 30 are permanently mounted, preferably with bolts, to the unit base 20. It is preferred that the seat base 34 or legs be mounted to the unit base 20. One of ordinary skill in the art would readily recognize that the way in which the seats 30 are mounted to the unit base 20 will vary depending on the style of the seat being used. The seats 30 in the preferred embodiment are of the kind currently used in fishing boats. Said seats are hinged between the seat back 32 and the sitting portion of the seat 35 such that the seat back 32 can be folded down for storage. Said seats 30 also have a single support member 36 stemming from the sitting portion of the seat 35 to the seat base 34.

Mounted to the unit base 20 in close proximity to the seats 30 are seatbelt assemblies 38. In the preferred embodiment, there is one seat belt assembly 38 for each seat 30. The seat belt assemblies 38 are of the kind currently used in automobiles as are known by one of ordinary skill in the art. Said seat belt assemblies 38 are securely mounted to the unit base 20 for added passenger safety.

Also mounted to the unit base 20 in the preferred embodiment is a roll bar 40. It is preferred that the roll bar 40 is constructed from steel and is of the type currently used in vehicles such as Jeep Wranglers®, etc. One of ordinary skill in the art would readily recognize that the roll bar 40 is an added safety feature, the removal of which would not alter the function of the present invention.

The preferred embodiment of the convertible jump seat for a pickup truck 10 also has a windshield 50 built into the roll bar 40. The windshield 50 can preferably be opened and/or closed by the passengers. In the preferred embodiment, the windshield 50 is constructed from a durable, transparent plastic such that if a rock or other debris hit the windshield 50, it would not shatter. One of ordinary skill in the art would recognize, however, that the windshield 50 can be made out of a number of materials, including, but not limited to, plexi-glass or safety glass. The windshield 50 can be tinted. The windshield 50 primarily exists in the preferred embodiment to protect the rear passengers from dirt and debris that may be flying at them and like the roll bar 40, is not necessary to the functionality of the convertible jump seat for a pickup truck 10.

Attached to the unit base 20, or molded as a part thereof in the preferred embodiment, is a storage cabinet 60. The storage cabinet 60 is devised such that the passengers have a place to secure their belongings while seated on the convertible jump seat for a pickup truck 10. As mentioned above, if, as in the preferred embodiment, the unit base/frame 20 is molded from fiberglass, it is preferred that the storage cabinet 60 be molded as part of the unit base/frame 20. If, however, an alternative embodiment of the convertible jump seat for a pickup truck 10 is constructed wherein the unit base 20 is made out of wood, metal, plastic, etc., then it is preferred that the storage cabinet 60 also be constructed from wood, metal, plastic., etc. and then securely fastened to the unit base 20.

To install the convertible jump seat for a pickup truck 10, the user lowers the tailgate 74 of the pickup truck 70, rolls the convertible jump seat for a pickup truck 10 over to the edge of the tailgate 74, lifts the unit 10 up onto the tailgate 74. The convertible jump seat for a pickup truck 10 can remain on the tailgate 74 or can be wheeled to sit within the truck bed 72. If left on the tailgate 74, it is preferred that a truck bed extender 76 be used for added safety. Truck bed extenders 76 are currently commercially available and any type that extends over the tailgate 74 of the truck 70 is acceptable to use. When the convertible jump seat for a pickup truck 10 is positioned on the tailgate 74, it can be used while a truck bed cover 78 is also in use.

If, on the other hand, the user decides to roll the convertible jump seat for a pickup truck 10 further into the truck bed 72, it is preferred that the tailgate 74 be closed for added safety. If the truck owner has a cab cover, he/she will most likely prefer to place the convertible jump seat for a pickup truck 10 on the tailgate 74. Once the convertible jump seat for a pickup truck 10 is in place, the user then securely fastens the convertible jump seat for a pickup truck 10 in place, preferably by bolting it to the side walls of the pickup truck 70 with the built in steel bolt 80. One of ordinary skill in the art would readily recognize that there are a number of different ways, including, but not limited to, tying the convertible jump seat for a pickup truck 10 to the pickup truck 70, for securing the convertible jump seat for a pickup truck 10 to the pickup truck 70.

Although this invention has certain preferred embodiments, it will be obvious to those skilled in the art that various changes and modifications may be made therein without departing from the invention, and all such changes and modifications are intended to fall within the true spirit and scope of the invention.

What is claimed is:

1. A convertible jump seat comprising:
a base having a first side and a second side;
at least one seat coupled to the first side of the base; and
a plurality of rollers coupled to the second side of the base for allowing the base to roll and glide.

2. The convertible jump seat of claim 1 further comprising at least one seatbelt assembly coupled to the first side of the base for keeping a passenger riding in the seat secure.

3. The convertible jump seat of claim 1 further comprising a means for securing the base to the bed of a pickup truck.

4. The convertible jump seat of claim 1 further comprising a storage cabinet coupled to the first side of the base.

5. The convertible jump seat of claim 1 wherein the back of each seat is collapsible.

6. The convertible jump seat of claim 1 wherein the seat faces the front of the pickup truck when the base is secured within the bed of a pickup truck.

7. A convertible jump seat comprising:
a base having a first side and a second side;
at least one seat coupled to the first side of the base;
a storage cabinet coupled to the first side of the base;
a plurality of rollers coupled to the second side of the base for allowing the base to roll and glide; and
a rollbar coupled to the first side of the base, said rollbar having a height larger that the height of the seat.

8. The convertible jump seat of claim 7 further comprising a seatbelt assembly coupled to the first side of the base for keeping a passenger riding in the seat secure.

9. The convertible jump seat of claim 7 further comprising a means for securing the base to the bed of a pickup truck.

10. The convertible jump seat of claim 7 wherein the back of each seat is collapsible.

11. The convertible jump seat of claim 7 wherein the seat faces the front of the pickup truck when the base is secured within the bed of a pickup truck.

12. The convertible jump seat of claim 7 wherein the rollbar has a window built thereinto to protect passengers from excess wind without impairing the view of the passengers.

13. A convertible jump seat comprising:
a base having a first side and a second side;
at least one seat coupled to the first side of the base;
a plurality of rollers coupled to the second side of the base for allowing the base to roll and glide; and
a rollbar coupled to the first side of the base, said rollbar having a height larger that the height of the seat.

14. The convertible jump seat of claim 13 further comprising a scatbelt assembly coupled to the first side of the base for keeping a passenger riding in the seat secure.

15. The convertible jump seat of claim 13 further comprising a means for securing the base to the bed of a pickup truck.

16. The convertible jump seat of claim 13 wherein the back of each seat is collapsible.

17. The convertible jump seat of claim 13 wherein the seat faces the front of the pickup truck when the base is secured within the bed of a pickup truck.

18. The convertible jump seat of claim 13 wherein the rollbar has a window built thereinto to protect passengers from excess wind without impairing the view of the passengers.
